(19) United States
(12) Patent Application Publication
(10) Pub. No.: US 2022/0100999 A1
(43) Pub. Date: Mar. 31, 2022

(54) SYSTEMS AND METHODS FOR SUSPECT VEHICLE IDENTIFICATION IN TRAFFIC MONITORING

(71) Applicant: Rekor Systems, Inc., Columbia, MD (US)

(72) Inventors: Matthew Anthony HILL, Sanford, NC (US); Addison Gerhard KLINKE, Denver, CO (US); Christopher Allen KADOCH, Leesburg, VA (US)

(21) Appl. No.: 17/489,936

(22) Filed: Sep. 30, 2021

Related U.S. Application Data
(60) Provisional application No. 63/085,813, filed on Sep. 30, 2020.

(51) Int. Cl. G06K 9/00; G08G 1/017

(52) U.S. Cl. CPC G06K 9/00664; G06K 9/00744; G06K 2209/15; G06K 2209/23; G08G 1/0175

(57) ABSTRACT

A traffic monitoring system includes one or more traffic sensors that generate recognition records by image processing captured images of respective vehicles. The recognition records are datasets of one or more characteristic values representing vehicle characteristics. The system also includes a server system communicatively coupled to the one or more traffic sensors. The server system has a holistic signature module that analyzes the recognition records so as to generate a vehicle signature for each of the respective vehicles, a database that stores the vehicle signatures, and a comparison module that compares a suspect vehicle signature with the vehicle signatures stored in the database, so as to identify one or more potential suspect vehicles whose vehicle signatures match the suspect vehicle signature in excess of a similarity threshold. The system also includes a user computer having a graphical-user-interface that displays captured images of the one or more potential suspect vehicles in a virtual line-up, and enables the user to select from among the one or more potential suspect vehicles in the virtual line-up.

### CROSS-REFERENCE TO RELATED APPLICATIONS

This application claims the benefit of U.S. Provisional Application No. 63/085,813, filed Sep. 30, 2020, the disclosures of which are expressly incorporated by reference herein.

### BACKGROUND

The present invention relates to traffic monitoring systems and methods, and more particularly to methods for identifying suspect vehicles in traffic monitoring.

In the forensic investigation process, witnesses frequently do not recall the plate number of a suspect vehicle (e.g., a vehicle involved in an incident such as a hit-and-run). More commonly the witness, will remember the approximate color or shade of the vehicle, and a few vehicle characteristics (e.g. damage, mismatched paint, bumper stickers, roof rack, spare tire, etc.). However, these identifying features are not easily leveraged in searching for matching suspect vehicles from imaging based traffic monitoring systems. Indeed, such traffic monitoring systems typically only identify vehicles by make, model and/or color, whereas witness memories may not be the most trustworthy when it comes to these features over features such as stickers, damage, etc. Thus, the identification of suspect vehicles from traffic monitoring systems is problematic.

It is therefore desirable to provide a traffic monitoring system that facilitates the accurate identification of suspect vehicles.

### BRIEF SUMMARY OF THE INVENTION

Systems and methods are disclosed that facilitate the accurate identification of suspect vehicles. In at least one embodiment, a traffic monitoring system includes one or more traffic sensors that generate recognition records by image processing captured images of respective vehicles. The recognition records are datasets of one or more characteristic values representing vehicle characteristics. The system also includes a server system communicatively coupled to the one or more traffic sensors. The server system has a holistic signature module that analyzes the recognition records so as to generate a vehicle signature for each of the respective vehicles, a database that stores the vehicle signatures, and a comparison module that compares a suspect vehicle signature with the vehicle signatures stored in the database, so as to identify one or more potential suspect vehicles whose vehicle signatures match the suspect vehicle signature in excess of a similarity threshold. The system also includes a user computer having a graphical-user-interface that displays captured images of the one or more potential suspect vehicles in a virtual line-up, and enables the user to select from among the one or more potential suspect vehicles in the virtual line-up.

Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples.

### BRIEF DESCRIPTION OF THE DRAWINGS

The features, objects, and advantages of the present invention will become more apparent from the detailed description, set forth below, when taken in conjunction with the drawings, in which like reference characters identify elements correspondingly throughout.

FIG. 1 illustrates an exemplary suspect vehicle identification system in accordance with at least one embodiment of the invention;

FIG. 2 illustrates an exemplary architecture of a traffic sensor architecture in accordance with at least one embodiment of the invention;

FIG. 3 illustrates an exemplary architecture of a server system in accordance with at least one embodiment of the invention; and

FIG. 4 illustrates an exemplary method for suspect vehicle identification in accordance with at least one embodiment of the invention.

### DETAILED DESCRIPTION OF THE PREFERRED EMBODIMENTS

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated.

In accordance with the practices of persons skilled in the art, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, well-known methods, procedures, components, and circuits have not been described in detail.

The present invention generally relates to traffic monitoring systems and methods, and more particularly to such systems and methods for identifying suspect vehicles via traffic monitoring.

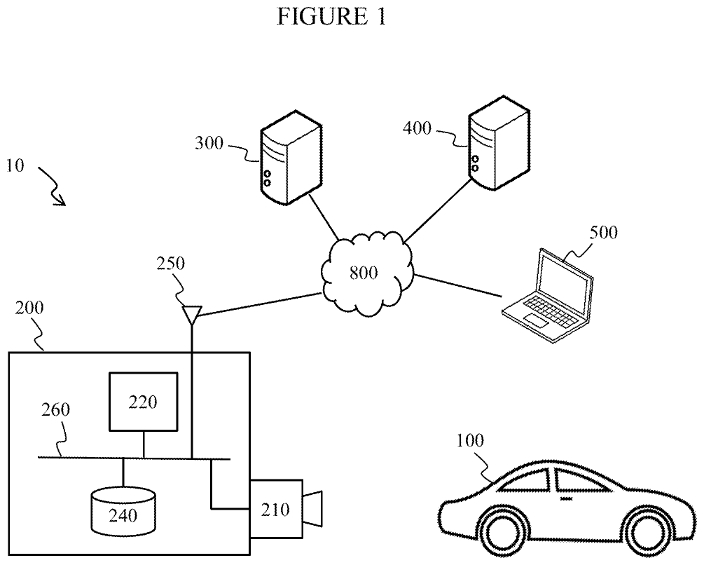

FIG. 1 is a schematic representation of a traffic monitoring system 10 in accordance with one or more aspects of the invention.

As shown in FIG. 1, the traffic monitoring system 10 comprises one or more traffic sensors 200 communicatively coupled to a system server 300, via a network 800. In general, the traffic monitoring system 10 enables the collection of traffic related data for transmission to a third-party server 400, via the network 800. The traffic related data includes one or more characteristics of passing vehicles, such as, for example, vehicle type, class, make, model, color, year, drive type (e.g., electric, hybrid, etc.), license plate number, registration, trajectory, speed, location, etc., or any combination thereof. Such characteristics also may include other visual identifiers, such as, for example, damage, mismatched paint, stickers, decals, roof racks, roll bars, spare tires, etc., or any combination therefore, including the location, type, extent and/or contents thereof.

Each traffic sensor 200 comprises an imaging device 210, a controller 220, a memory 240, and a transceiver 250, each communicatively coupled to a data bus 260 that enables data communication between the respective components.

The imaging device 210 is configured to capture images of traffic, in particular, video images of vehicles 100 making up the traffic, and generates video data therefrom. The imaging device 210 may be a video camera of any camera type, which captures video images suitable for computerized image recognition of objects within the captured images. For example, the camera may utilize charge-coupled-device (CCD), complementary metal-oxide-semiconductor (CMOS) and/or other imaging technology, to capture standard, night-vision, infrared, and/or other types of images, having predetermined resolution, contrast, color depth, and/or other image characteristics. The video data may be timestamped so as to indicate the date and time of recording.

The controller 220 is configured to control the operation of the other components of the imaging device 210 in accordance with the functionalities described herein. The controller may be one or more processors programmed to carry out the described functionalities in accordance software stored in the memory 240. Each processor may be a standard processor, such as a central processing unit (CPU), a graphics processing unit (GPU), or a dedicated processor, such as an application-specific integrated circuit (ASIC) or field programmable gate array (FPGA), or portion thereof.

The memory 240 stores software and data that can be accessed by the processor(s), and includes both transient and persistent storage. The transient storage is configured to temporarily store data being processed or otherwise acted on by other components, and may include a data cache, RAM or other transient storage types. The persistent storage is configured to store software and data until deleted.

The transceiver 250 communicatively couples the traffic sensor 200 to the network 800 so as to enable data transmission therewith. The network 800 may be any type of network, wired or wireless, configured to facilitate the communication and transmission of data, instructions, etc., and may include a local area network (LAN) (e.g., Ethernet or other IEEE 802.03 LAN technologies), Wi-Fi (e.g., IEEE 802.11 standards, wide area network (WAN), virtual private network (VPN), global area network (GAN)), a cellular network, or any other type of network or combination thereof.

The system server 300 is generally configured to provide centralized support for the traffic sensors 200. The system server 300 is configured to receive, store and/or process traffic sensor generated data, from each of the traffic sensors 200. In particular, the system server 300 is a server of a traffic monitoring service.

The system server is also generally configured to support a suspect vehicle identification platform. The suspect vehicle identification platform provides a graphical user interface to the user computer 500, via which a user inputs one or more suspect vehicle characteristics. The user is preferably a witness tasked with identifying the suspect vehicle, which may, for example, have been involved in a hit-and-run accident. The suspect vehicle characteristics are communicated to the system server for the identification of one or more suspect vehicles. The suspect vehicle identification platform also allows for user selection of a suspect vehicle from among the one or more suspect vehicles. As such, the suspect vehicle identification platform enables the identification of the suspect vehicle from among the one or more suspect vehicles.

The third-party server 400 is generally configured to send and receive data from the system server 300. The third-party server may be one or more servers of law-enforcement (e.g., police, highway patrol, sheriff, etc.), civil service (e.g., department of transportation, municipality, etc.) and private (e.g., trucking, security, etc.) entities.

In general, each server many include one or more server computers connected to the network 800. Each server computer may include computer components, including one or more processors, memories, displays and interfaces, and may also include software instructions and data for executing the functions of the server described herein. The servers may also include one or more storage devices configured to store large quantities of data and/or information, and may further include one or more databases. For example, the storage device may be a collection of storage components, or a mixed collection of storage components, such as ROM, RAM, hard-drives, solid-state drives, removable drives, network storage, virtual memory, cache, registers, etc., configured so that the server computers may access it. The storage components may also support one or more databases for the storage of data therein.

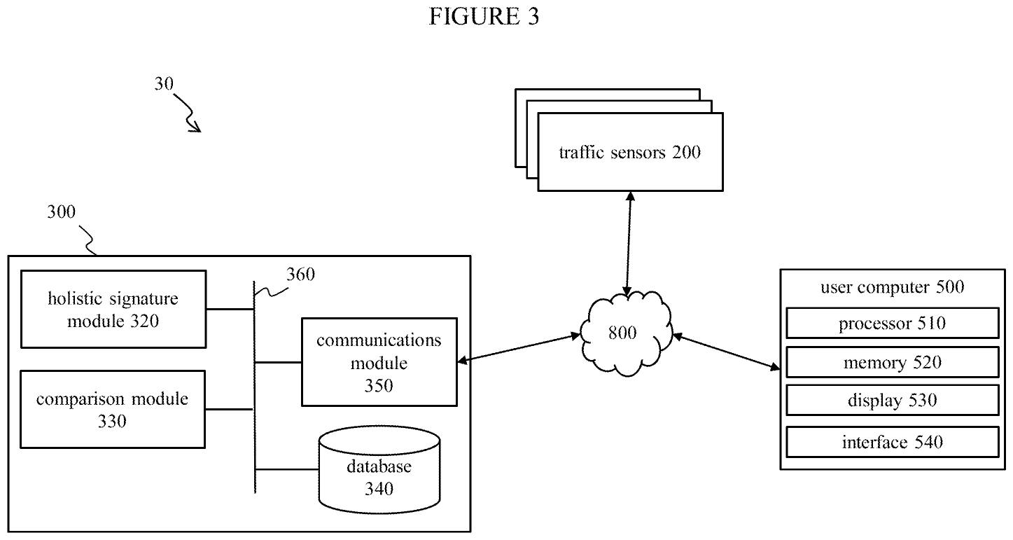

The user computer 500 is generally configured to support the graphical user interface via which the user interacts with the suspect vehicle identification platform. The user computer 500 may be any computer-based electronic device, including mobile devices (e.g., laptops computers, tablet computers, smartphones, PDAs, etc.) or stationary devices (e.g., desktop computer, etc.). As shown in FIG. 3, the user computer 500 generally includes a processor 510, a memory 520, a display 530, and an input/output interface 540, all known in the art. The user computer 500 may be part of the system server 300 or the third-party server 400, or may be independent of both. In some embodiments, the user computer may further include application software installed on the user computer 500 so as to enable the functionality described herein.

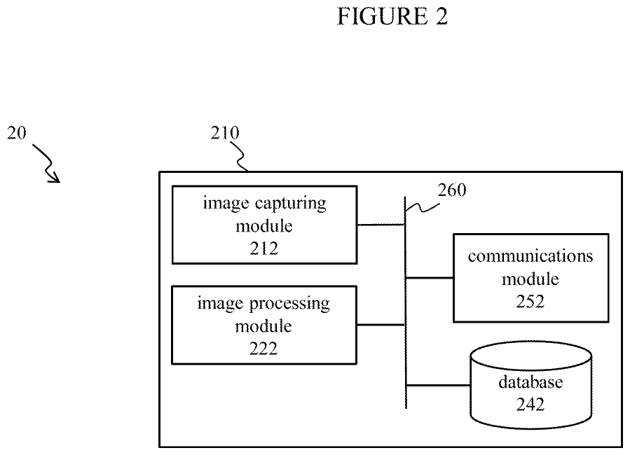

FIG. 2 is a schematic representation of an exemplary architecture 20 of the traffic sensor 200/imaging device 210 in accordance with one or more aspects of the invention. The architecture includes an image capturing module 212, an image processing module 226, a communications module 252, and a database 242, communicatively coupled via the data bus 260. Each of the modules may be implemented via appropriate hardware and/or software, namely, as controller data processing and/or control of appropriate hardware components of the traffic sensor 200/imaging device 210.

The image capturing module 212 is configured to capture, via the imaging device 210, images of traffic, namely, video images of vehicles 100 making up the traffic, and generates video data therefrom. The video data is generally a series of time-sequenced image frames, and may be timestamped so as to indicate the date and time of recording.

The image processing module 226 is configured to perform image recognition processing on the video data so as to identify the traffic related data. In particular, the image processing module 226 uses image recognition techniques to identify passing vehicles and the one or more characteristics thereof. Such characteristics may include, for example, vehicle type, class, make, model, color, year, drive type (e.g., electric, hybrid, etc.), license plate number, registration, trajectory, speed, location, etc., or any combination thereof. The vehicle characteristics also may include other visual identifiers, such as, for example, damage, mismatched paint, stickers, decals, roof racks, roll bars, spare tires, etc., or any combination therefore, including the location, type, extent and/or contents thereof.

The image processing module 226 is also configured to generate a recognition record for each identified vehicle. The recognition record is preferably a dataset of the recognized vehicle characteristic values, i.e., characteristic data. For example, the characteristic data for the license plate number is the image recognized license plate number. The recognition record preferably includes characteristic data for as many vehicle characteristics as can be captured by the imaging device 210. In at least one embodiment, the recognition record may also include the timestamp of the associated video data from which the recognition record is generated, and one or more images of the vehicle. The recognition record is preferably in the form of a data object, such as a representative image of the vehicle, whose metadata reflects the associated characteristic data.

The recognition record may be retrievably stored in the database 242 of the memory 240 and/or transmitted to the system server 300 via the communications module 252 operating the transceiver 250. In particular, the recognition record may be transmitted to the system server 300 for further processing, as discussed herein.

FIG. 3 is a schematic representation of an exemplary system architecture 30 of the traffic monitoring system 10.

The holistic signature module 320 is configured to analyze recognition records received from the traffic sensors 200 via the communications module 350, and to determine a vehicle signature for each vehicle therefrom. The vehicle signatures are defined in a multidimensional comparative feature space reflecting the possible characteristic data values of the recognition records. The holistic signature module 320 is also configured to analyze suspect vehicle characteristics received from the user computer 500 via the communications module 350, and to determine a suspect vehicle signature therefrom. The suspect vehicle signature is defined in the same multidimensional comparative feature space as the vehicle signatures.

The holistic signature module 320 may utilize machine learning, neural networks and/or artificial intelligence to determine the vehicle signatures and the suspect vehicle signature. In at least one embodiment, the holistic signature module may comprise a convoluted neural network that analyzes vehicle characteristics to define each signature in the multidimensional comparative feature space.

The comparison module 330 is configured to compare the suspect vehicle signature with the vehicle signatures stored in the database 340 so as to identify one or more suspect vehicles whose vehicle signatures most closely match the suspect vehicle signatures.

The comparison module 330 may utilize machine learning, neural networks and/or artificial intelligence to determine the vehicle signatures and the suspect vehicle signature. In at least one embodiment, the comparison module 330 may comprise a convoluted neural network that compares the signatures in the multidimensional feature space. The comparison may de-emphasize features that are unknown from the suspect vehicle characteristics, and/or may emphasize features that are known from the suspect vehicle characteristics. Accordingly, the comparison module 330 provides a holistic visual similarity check of user-recalled vehicle characteristics of the suspect vehicle against the vehicles whose recordation records are stored in the database 340.

In some embodiments, the comparison module 330 is configured to determine a confidence value for each comparison. Accordingly, a confidence threshold may be set such that the identified suspect vehicles are those whose comparisons with the suspect vehicle signature generated confidence values above the threshold. In some embodiments, a numerical threshold N may be set such that the comparison module identifies the top N matches as the suspect vehicles.

In at least one embodiment, the comparison module 330 generates a suspect vehicle identification data object, which identifies the suspect vehicles and their associated confidence values, and includes at least a corresponding representative image of the suspect vehicle. The representative image may be retrieved from the corresponding recordation record saved in the database 340. The suspect vehicles may be identified via reference to their corresponding recordation records saved in the database 340.

In at least one embodiment, the suspect vehicle identification data object is transmitted, via the communications module, to the user computer such that the user can identify a suspect vehicle from among the one or more suspect vehicles. The suspect vehicle identification platform preferably causes the display of a virtual lineup of the corresponding images of the one or more suspect vehicles on the user computer. The images of the virtual lineup may be randomly ordered, or may be ordered according to confidence value. In some embodiments, the confidence values are displayed with the corresponding images.

The virtual lineup preferably allows for the user to select the suspect vehicle from among the one or more suspect vehicles. As such, the suspect vehicle identification platform enables user identification of the suspect vehicle from among the one or more suspect vehicles.

In at least one embodiment, the system server is further configured to receive the user selection via the communications module 350. The system server is further configured to, in response to the selection, retrieve the corresponding recordation record from the database 340 and transmit it to the third-party server 400 (e.g., law-enforcement server). The recordation record may be transmitted in connection with data identifying the user selection. In at least one embodiment, the user selection data is transmitted in connection with the recordation records of each of the one or more suspect vehicles. The user selection data may further be transmitted with any other data stored at the system server.

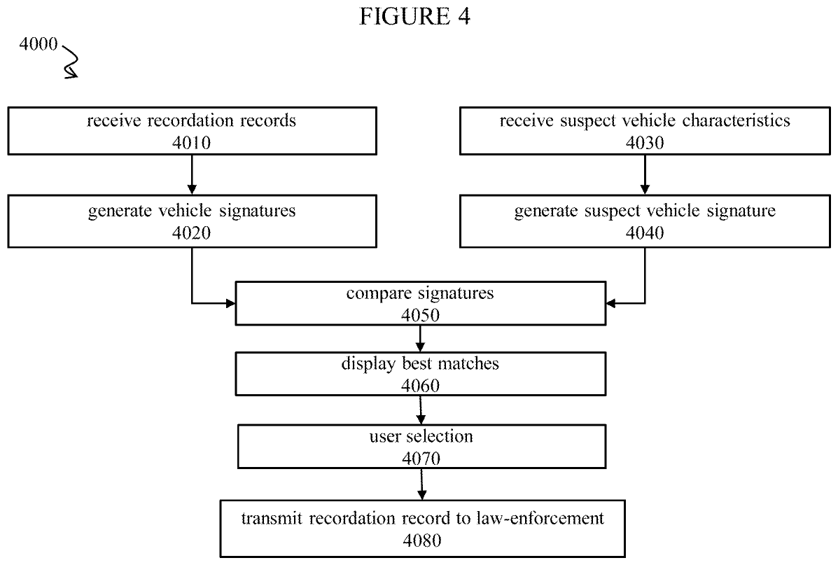

FIG. 4 is a flow-chart representing an exemplary method 40 in accordance with one or more aspects of the invention.

At step 4010, the traffic sensor 200 captures images of traffic, namely, video images of vehicles 100 making up the traffic, and generates recognition records therefrom. Each recognition records is preferably a dataset of the recognized vehicle characteristic values, i.e., characteristic data, for a corresponding recognized vehicle. The vehicle characteristics generally includes one or more characteristics such as, for example, vehicle type, class, make, model, color, year, drive type (e.g., electric, hybrid, etc.), license plate number, registration, trajectory, speed, location, etc., or any combination thereof. Such characteristics also may include other visual identifiers, such as, for example, damage, mismatched paint, stickers, decals, roof racks, roll bars, spare tires, etc., or any combination therefore, including the location, type, extent and/or contents thereof.

At step 4020, the holistic signature module 320 analyzes the recognition records received from the traffic sensors 200 via the communications module 350, and determines a vehicle signature for each vehicle therefrom. The vehicle signatures are defined in a multidimensional comparative feature space reflecting the possible characteristic data values of the recognition records. The holistic signature module 320 may utilize machine learning, neural networks and/or artificial intelligence to determine the vehicle signatures. In at least one embodiment, the holistic signature module may comprise a convoluted neural network that analyzes vehicle characteristics to define each signature in the multidimensional comparative feature space.

At step 4020, the suspect vehicle identification platform receives the user-inputted one or more suspect vehicle characteristics. The user is preferably a witness tasked with identifying the suspect vehicle, which may, for example, have been involved in a hit-and-run accident. Here too, the vehicle characteristics generally includes one or more characteristics such as, for example, vehicle type, class, make, model, color, year, drive type (e.g., electric, hybrid, etc.), license plate number, registration, trajectory, speed, location, etc., or any combination thereof. Such characteristics also may include other visual identifiers, such as, for example, damage, mismatched paint, stickers, decals, roof racks, roll bars, spare tires, etc., or any combination therefore, including the location, type, extent and/or contents thereof.

At step 4030, the holistic signature module analyzes the suspect vehicle characteristics received from the user computer 500 via the communications module 350, and determines a suspect vehicle signature therefrom. The suspect vehicle signature is defined in the same multidimensional comparative feature space as the vehicle signatures. The holistic signature module 320 may utilize machine learning, neural networks and/or artificial intelligence to determine the suspect vehicle signature. In at least one embodiment, the holistic signature module may comprise a convoluted neural network that analyzes vehicle characteristics to define each signature in the multidimensional comparative feature space.

At step 4050, the comparison module 330 compares the suspect vehicle signature with the vehicle signatures stored in the database 340 so as to identify one or more suspect vehicles whose vehicle signatures most closely match the suspect vehicle signatures. The comparison module 330 may utilize machine learning, neural networks and/or artificial intelligence to determine the vehicle signatures and the suspect vehicle signature. In at least one embodiment, the comparison module 330 may comprise a convoluted neural network that compares the signatures in the multidimensional feature space. Accordingly, the comparison module 330 provides a holistic visual similarity check of user-recalled vehicle characteristics of the suspect vehicle against the vehicles whose recordation records are stored in the database 340.

At step 4060, the suspect identification platform displays the one or more suspect vehicles to the user, via the user computer, such that the user can identify a suspect vehicle from among the one or more suspect vehicles. The one or more suspect vehicles are preferably displayed as a virtual lineup of images corresponding to the one or more suspect vehicles.

At step 4070, the user selects the suspect vehicle from among the one or more suspect vehicles. As such, the user is presented with potential suspect vehicles (i.e., the one or more suspect vehicles), and is permitted to identify the suspect vehicle (e.g., the vehicle from the hit-and-run) from among the one or more suspect vehicles.

At step 4080, the system server receives the user selection and transmits the corresponding recordation record to the third-party server 400 (e.g., law-enforcement server). The recordation record may be transmitted in connection with data identifying the user selection. In at least one embodiment, the user selection data is transmitted in connection with the recordation records of each of the one or more suspect vehicles. The user selection data may further be transmitted with any other data stored at the system server.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A traffic monitoring system, comprising:
one or more traffic sensors, each traffic sensor configured to generate recognition records by image processing captured images of respective vehicles, wherein the recognition records each comprise a dataset of one or more characteristic values representing vehicle characteristics;
a server system communicatively coupled to the one or more traffic sensors, the server system comprising:
a holistic signature module configured to analyze the recognition records so as to generate a vehicle signature for each of the respective vehicles,
a database configured to store the vehicle signatures,
a comparison module configured to compare a suspect vehicle signature with the vehicle signatures stored in the database, so as to identify one or more potential suspect vehicles whose vehicle signatures match the suspect vehicle signature in excess of a similarity threshold,
a user computer communicatively coupled to the server system and having a graphical-user-interface configured to:
display captured images of the one or more potential suspect vehicles in a virtual line-up, and
enable the user to select from among the one or more potential suspect vehicles in the virtual line-up.

2. The traffic monitoring system of claim 1, wherein the vehicle characteristics include one or more of: vehicle type, class, make, model, color, year, drive type, license plate number, registration, trajectory, speed and location.

3. The traffic monitoring system of claim 1, the vehicle characteristics include one or more of: damage location and type, mismatched paint location and color(s), sticker and/or decal location and type, and vehicle accessory (e.g., roof racks, roll bars, spare tires, etc.) location and/or type.

4. The traffic monitoring system of claim 1, the vehicle signatures are defined in a multidimensional comparative feature space reflecting possible characteristic data values for each vehicle characteristic.

5. The traffic monitoring system of claim 1,
wherein the graphical-user-interface is further configured to: receive user input identifying one or more characteristic values representing vehicle characteristics of the suspect vehicle, and
wherein the holistic signature module is further configured to: analyze the user input so as to generate the suspect vehicle signature.

6. The traffic monitoring system of claim 1, wherein the similarity threshold provides for a predetermined number of potential suspect vehicles.

7. The traffic monitoring system of claim 1, wherein the database is further configured to:
store the recordation records, and
retrieve the recordation record of the user selected potential suspect vehicle in response to the user selection.

8. The traffic monitoring system of claim 1, wherein the server system further comprises:
a communications unit configured to transmit the recordation record of the user selected potential suspect vehicle to a third-party server in response to the user selection.

9. A traffic monitoring method, comprising:
generating recognition records by image processing traffic sensor captured images of respective vehicles, wherein the recognition records each comprise a dataset of one or more characteristic values representing vehicle characteristics;
analyzing the recognition records, via a holistic signature module of a server system, so as to generate a vehicle signature for each of the respective vehicles,
storing the vehicle signatures in a database of the server system,
comparing, via a comparison module of the server system, a suspect vehicle signature with the vehicle signatures stored in the database, so as to identify one or more potential suspect vehicles whose vehicle signatures match the suspect vehicle signature in excess of a similarity threshold,
displaying, via a graphical-user-interface of a user-computer, captured images of the one or more potential suspect vehicles in a virtual line-up, and
enabling the selection, via the graphical-user-interface, from among the one or more potential suspect vehicles in the virtual line-up.

10. The traffic monitoring method of claim 9, wherein the vehicle characteristics include one or more of: vehicle type, class, make, model, color, year, drive type, license plate number, registration, trajectory, speed and location.

11. The traffic monitoring method of claim 9, the vehicle characteristics include one or more of: damage location and type, mismatched paint location and color(s), sticker and/or decal location and type, and vehicle accessory (e.g., roof racks, roll bars, spare tires, etc.) location and/or type.

12. The traffic monitoring method of claim 9, the vehicle signatures are defined in a multidimensional comparative feature space reflecting possible characteristic data values for each vehicle characteristic.

13. The traffic monitoring method of claim 9, further comprising:
receiving, at the graphical-user-interface, user input identifying one or more characteristic values representing vehicle characteristics of the suspect vehicle; and
analyzing, via the holistic signature module, the user input so as to generate the suspect vehicle signature.

14. The traffic monitoring method of claim 9, wherein the similarity threshold provides for a predetermined number of potential suspect vehicles.

15. The traffic monitoring method of claim 9, further comprising:
storing the recordation records in the database; and
retrieving the recordation record of the user selected potential suspect vehicle in response to the user selection.

16. The traffic monitoring method of claim 9, further comprising:
transmitting, from the server system, the recordation record of the user selected potential suspect vehicle to a third-party server in response to the user selection.
